(19) United States
(12) Patent Application Publication
(10) Pub. No.: US 2026/0269524 A1
(43) Pub. Date: Sep. 10, 2026

(54) CONNECTOR

(71) Applicant: SUMITOMO WIRING SYSTEMS, LTD., Mie (JP)

(72) Inventors: Kuniaki TANIDA, Mie (JP); Kazuo NAKAI, Mie (JP)

(21) Appl. No.: 19/556,333

(22) Filed: Mar. 4, 2026

(30) Foreign Application Priority Data
Mar. 7, 2025 (JP) 2025-036266

(51) Int. Cl. H01R 13/629

(52) U.S. Cl. CPC H01R 13/62938

(57) ABSTRACT

A connector includes a housing including a first flange, a first fixing shaft made of resin, and an operation lever. The first fixing shaft includes a shaft portion and a lock protrusion for sandwiching a casing between the lock protrusion and the first flange. The connector includes a cam mechanism that converts movement of the operation lever in an operating direction into movement of the first fixing shaft in an axial direction and converts the movement of the operation lever in the operating direction into movement of the first fixing shaft in a rotational direction about an axis. The first fixing shaft moves between a locked position at which the casing is sandwiched between the first flange and the lock protrusion and an initial position. A rotational position of the first fixing shaft located at the locked position is different from a rotational position of the first fixing shaft.

### CROSS-REFERENCE TO RELATED APPLICATIONS

This application is based on and claims priority from Japanese Patent Application No. 2025-036266, filed on Mar. 7, 2025, with the Japan Patent Office, the disclosure of which is incorporated herein in its entirety by reference.

### TECHNICAL FIELD

The present disclosure relates to a connector.

### BACKGROUND

A connector disclosed in JP 2010-211935 A includes a high-voltage electric wire bent into an L-shape, a terminal connected to a leading end of the high-voltage electric wire, a housing surrounding the leading end portion of the high-voltage electric wire and the terminal, and a shield shell covering the housing and fixed to the housing.

### SUMMARY

The connector disclosed in JP 2010-211935 A includes a flange that protrudes outward and has a through hole. The connector disclosed in JP 2010-211935 A is fixed to a casing by, for example, fastening a bolt inserted through the through hole of the flange to a screw hole provided in the casing. In the case of a structure that uses a bolt for fixing, metal constituting the bolt may corrode. If the bolt gets stuck due to the corrosion of metal, it becomes difficult to remove the connector from the casing.

An object of the present disclosure is to provide a connector that can suppress deterioration of handleability due to corrosion.

A connector according to the present disclosure includes: a housing; a fixing shaft made of resin and configured to fix the housing to a plate-shaped casing; and an operation lever for operating the fixing shaft, wherein the housing includes a main body and a flange protruding outward from the main body, the fixing shaft includes a shaft portion that is inserted through a through hole provided in the flange and a lock protrusion protruding from an outer circumferential surface of the shaft portion and configured to sandwich the casing between the lock protrusion and the flange, the fixing shaft and the operation lever include a cam mechanism configured to convert movement of the operation lever in an operating direction into movement of the fixing shaft in an axial direction and convert the movement of the operation lever in the operating direction into movement of the fixing shaft in a rotational direction about an axis. In conjunction with the movement of the operation lever in the operating direction, the fixing shaft moves between a locked position at which the casing is sandwiched between the flange and the lock protrusion and an initial position at which a distance between the lock protrusion and the flange is longer than that at the locked position, and a rotational position of the fixing shaft about the axis when the fixing shaft is located at the locked position is different from a rotational position of the fixing shaft about the axis when the fixing shaft is located at the initial position.

The connector according to the present disclosure can suppress deterioration of handleability due to metal corrosion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector showing a state in which a first fixing shaft is located at an initial position in an embodiment.

FIG. 2 is an exploded perspective view of the connector according to the embodiment.

FIG. 3 is a plan view of an operation lever according to the embodiment.

FIG. 4 is a cross-sectional view taken along a line 4-4 in FIG. 3.

FIG. 5 is a cross-sectional view taken along a line 5-5 in FIG. 3.

FIG. 6 is a perspective view of the first fixing shaft according to the embodiment.

FIG. 7 is a perspective view of the first fixing shaft according to the embodiment, as viewed from a direction different from the direction of FIG. 6.

FIG. 8 is an enlarged perspective view of the first fixing shaft and the operation lever according to the embodiment.

FIG. 9 is a side view showing a state in which the first fixing shaft is located at the initial position in the embodiment.

FIG. 10 is a side view showing a state in which the first fixing shaft is located at a top position in the embodiment.

FIG. 11 is a side view showing a state in which the first fixing shaft is located at a locked position in the embodiment.

FIG. 12 is a perspective view showing a state in which the first fixing shaft is located at the initial position in the embodiment.

FIG. 13 is a perspective view showing a state in which the first fixing shaft is located at the locked position in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] A connector including: a housing; a fixing shaft made of resin and configured to fix the housing to a plate-shaped casing; and an operation lever for operating the fixing shaft, wherein the housing includes a main body and a flange protruding outward from the main body, the fixing shaft includes a shaft portion that is inserted through a through hole provided in the flange and a lock protrusion protruding from an outer circumferential surface of the shaft portion and configured to sandwich the casing between the lock protrusion and the flange, the fixing shaft and the operation lever include a cam mechanism configured to convert movement of the operation lever in an operating direction into movement of the fixing shaft in an axial direction and convert the movement of the operation lever in the operating direction into movement of the fixing shaft in a rotational direction about an axis. In conjunction with the movement of the operation lever in the operating direction, the fixing shaft moves between a locked position at which the casing is sandwiched between the flange and the lock protrusion and an initial position at which a distance between the lock protrusion and the flange is longer than that at the locked position, and a rotational position of the fixing shaft about the axis when the fixing shaft is located at the locked position is different from a rotational position of the fixing shaft about the axis when the fixing shaft is located at the initial position.

According to this configuration, the fixing shaft used to fix the housing to the casing is made of resin. This prevents the occurrence of metal corrosion in the fixing shaft in the state where the connector is fixed to the casing, and prevents the fixing shaft from getting stuck due to the metal corrosion. Therefore, deterioration of handleability due to the metal corrosion can be suppressed.

[2] In [1] described above, the cam mechanism may include an axial direction cam that converts movement of the operation lever in a rotational direction into the movement of the fixing shaft in the axial direction, and the fixing shaft may be coupled to the operation lever in such a manner as to be rotatable relative to the operation lever about a second center that is eccentric to a first center that is a rotation center of the operation lever.

With this configuration, by employing an eccentric cam having a simple structure, it is possible to suppress an increase in the number of components of members constituting the cam mechanism and complication of the shapes of the members constituting the cam mechanism.

[3] In [2] described above, when a position of the fixing shaft when the second center is farthest from the flange is defined as a top position, the axial direction cam may be configured such that the fixing shaft moves from the locked position to the initial position via the top position in conjunction with the movement of the operation lever in the operating direction.

According to this configuration, when the fixing shaft is located at the top position, holding pressure applied by the protrusion of the fixing shaft to press the casing becomes the maximum, and a strong resisting force that pushes back the protrusion is generated as a reaction. Therefore, a force exceeding this resisting force is necessary to pass through the top position when the operation lever is moved from a position at which the fixing shaft is located at the locked position to a position at which the fixing shaft is located at the initial position. Accordingly, when the fixing shaft is located at the locked position, even if a force is applied by unintentional contact or the like to the operation lever in a direction to rotate the operation lever, it is possible to suppress rotation of the operation lever in such a direction that the fixing of the connector is canceled. As a result, the connector can be stably fixed to the casing.

[4] In any one of [1] to [3] described above, the cam mechanism may include a rotational direction cam that converts movement of the operation lever in a rotational direction into the movement of the fixing shaft in the rotational direction about the axis, the rotational direction cam may include a pushing portion provided on the operation lever, and when the operation lever is moved in the rotational direction, the pushing portion may move around a first center that is a rotation center of the operation lever, come into contact with the fixing shaft, and rotate the fixing shaft about the axis.

With this configuration, the structure of the rotational direction cam can be simplified. Therefore, it is possible to suppress an increase in the number of components of members constituting the cam mechanism and complication of the shapes of the members constituting the cam mechanism.

[5] In any one of [1] to [4] described above, the flange may include a first flange and a second flange located on opposite sides with the main body therebetween, the fixing shaft may include a first fixing shaft inserted through the through hole provided in the first flange and a second fixing shaft inserted through the through hole provided in the second flange, and the first fixing shaft and the second fixing shaft may operate in conjunction with operation of the single operation lever. With this configuration, the connector can be fixed to the casing more stably with the two fixing shafts. Also, the two fixing shafts can be easily operated by one operation.

[6] In any one of [1] to [5] described above, when a position of the operation lever when the fixing shaft is located at the locked position is defined as a lever lock position, the operation lever may include a lever lock portion configured to retain the operation lever at the lever lock position by being locked to the housing or a member attached to the housing when the operation lever comes to the lever lock position.

According to this configuration, when the operation lever is located at the lever lock position, even if a force is applied by unintentional contact or the like to the operation lever in a direction to rotate the operation lever, it is possible to suppress rotation of the operation lever in the direction in which the fixing of the connector by the fixing shaft is canceled. As a result, the connector can be stably fixed to the casing.

### Details of Embodiment of Present Disclosure

A specific example of a connector according to the present disclosure will be described below with reference to the drawings. In the drawings, a part of a configuration may be exaggerated or simplified for convenience of description. Also, dimensional proportions of respective portions may be different between the drawings. In this specification, "orthogonal" and "parallel" include not only strictly orthogonal and parallel cases, but also substantially orthogonal and parallel cases within a range where functions and effects of the present embodiment are achieved. The terms "first", "second", "third", and the like as used herein are used merely to distinguish objects from each other, and do not indicate an order of the objects.

In each of the drawings, an X-axis, a Y-axis, and a Z-axis that are orthogonal to each other are shown. The following describes, as an example, a case in which a connector 10 is oriented such that the Z-axis direction is an upward direction. The connector 10 is not limited to being used in this orientation, and may be used in an orientation in which the Z-axis direction is other than the upward direction, for example, a downward direction or a horizontal direction. Note that axial directions such as the Z-axis direction mean the directions in which the tips of the arrows of the corresponding axes are directed. The upward direction means a vertically upward direction, and the downward direction means a vertically downward direction.

### Configuration of Connector 10

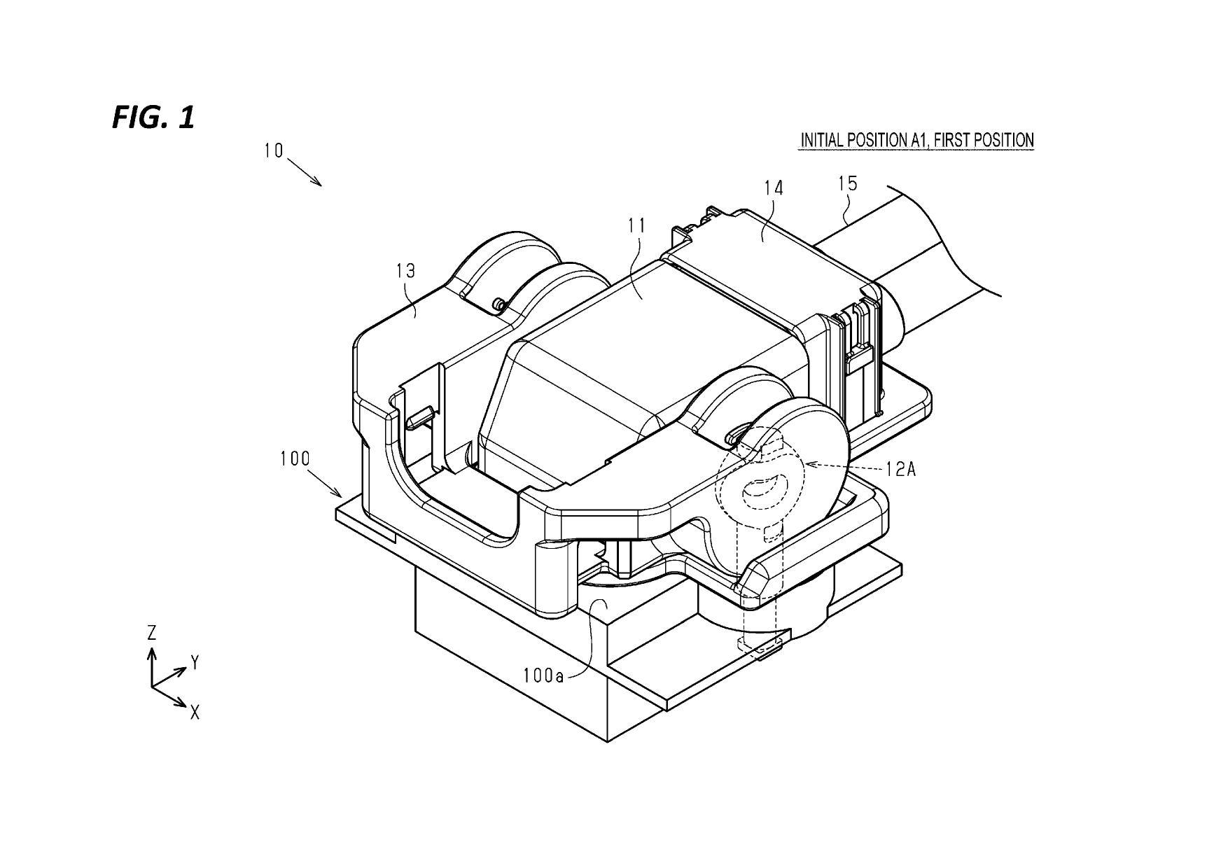

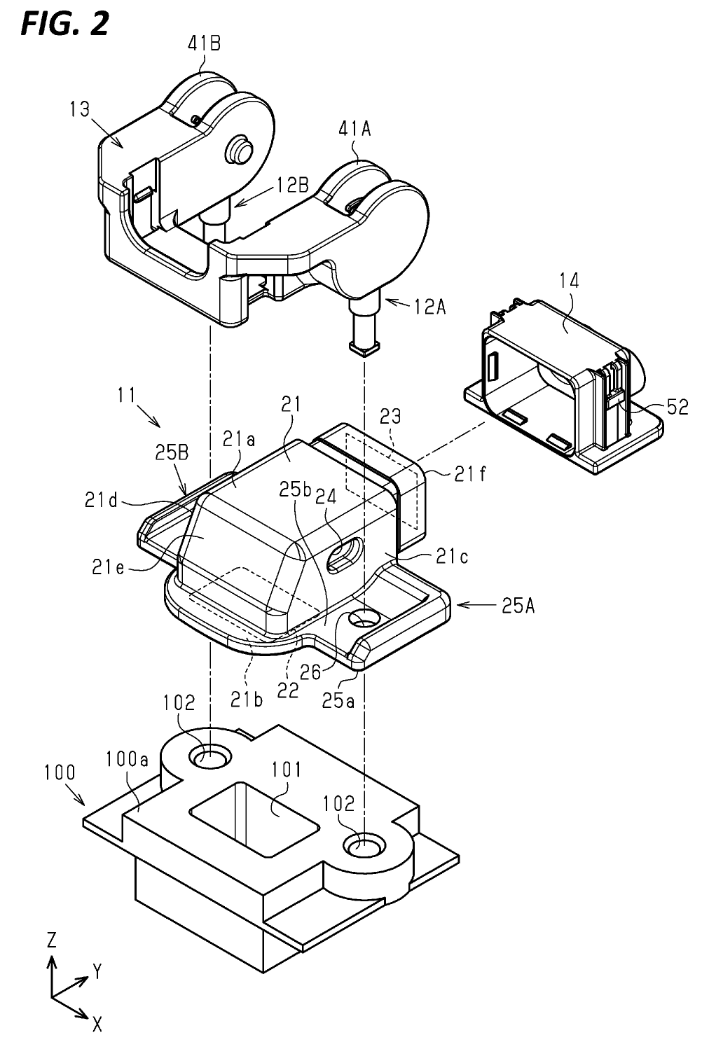

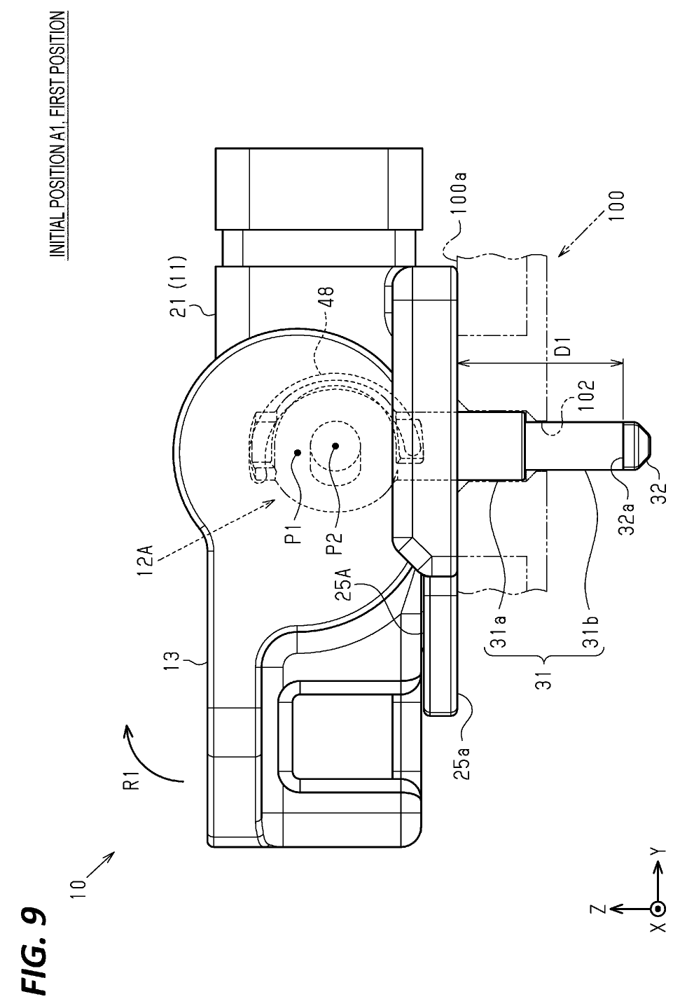

As shown in FIGS. 1 and 2, the connector 10 includes a housing 11, a first fixing shaft 12A and a second fixing shaft 12B for fixing the housing 11 to a plate-shaped casing 100, and a single operation lever 13 for operating the first fixing shaft 12A and the second fixing shaft 12B. The connector 10 further includes terminals (not shown) and a retainer 14, which are attached to the housing 11, and a plurality of electric wires 15 accommodated in the housing 11. The terminals are accommodated in, for example, a fitting portion (not shown) that is attached to a first opening 22 of the housing 11, which will be described later. The retainer 14 is attached to the housing 11 so as to be in communication with a second opening 23 of the housing 11, which will be described later. First end portions of the electric wires 15, which are end portions on one side, are connected to the terminals, and second end portions opposite to the first end portions are drawn out to the outside through the retainer 14. The electric wires 15 are omitted in FIG. 2 and the following drawings. The retainer 14 is omitted in FIGS. 9, 10, and 11.

### Structure of Housing 11

As shown in FIG. 2, the housing 11 includes a main body 21 that accommodates the electric wires 15.

The main body 21 has a box shape and has an accommodation space for accommodating the electric wires 15. The shape of the main body 21 is not particularly limited, and can be set as appropriate according to the arrangement of the electric wires 15 and the like. The following describes, as an example, the main body 21 configured to accommodate the electric wires 15 bent into an L-shape.

The main body 21 has a quadrilateral box shape as viewed in the Z-axis direction. The main body 21 has an upper wall 21a and a lower wall 21b next to each other in the Z-axis direction with a distance therebetween, a first side wall 21c and a second side wall 21d next to each other in the X-axis direction with a distance therebetween, and a third side wall 21e and a fourth side wall 21f next to each other in the Y-axis direction with a distance therebetween. The first opening 22, which is open downward, is provided in the lower wall 21b. The second opening 23, which is open rearward (in the Y-axis direction), is provided in an upper portion of the fourth side wall 21f. For example, the fitting portion accommodating the terminals is attached to the first opening 22. The retainer 14 is attached to the rear of the main body 21. The accommodation space in the main body 21 forms an L-shaped passage extending from the first opening 22 to the second opening 23.

A bearing portion 24 is provided in an outer surface of the first side wall 21c. The bearing portion 24 is a recessed portion having an oval shape extending in the Y-axis direction. A bearing portion 24 is also provided in an outer surface of the second side wall 21d.

The housing 11 includes a first flange 25A and a second flange 25B protruding outward from the main body 21. The first flange 25A and the second flange 25B are located on opposite sides with the main body 21 therebetween. The first flange 25A protrudes in the X-axis direction from a lower end of the first side wall 21c. The first flange 25A has a plate shape including a lower surface 25a on the lower side and an upper surface 25b opposite to the lower surface 25a. The lower surface 25a of the first flange 25A is flush with a lower surface of the lower wall 21b of the main body 21. The first flange 25A has a through hole 26 extending through the first flange 25A in the Z-axis direction. The through hole 26 has a circular cross-sectional shape. An example of the cross-sectional shape of the through hole 26 is constant in the Z-axis direction.

The second flange 25B protrudes in the direction opposite to the X-axis direction from a lower end of the second side wall 21d. The configuration of the second flange 25B is the same as that of the first flange 25A except that the orientation of the second flange 25B is different from that of the first flange 25A.

### Configuration of Operation Lever 13

As shown in FIG. 2, the operation lever 13 includes a first rotary portion 41A to which the first fixing shaft 12A is attached and a second rotary portion 41B to which the second fixing shaft 12B is attached. The first rotary portion 41A and the second rotary portion 41B have symmetrical structures that are in a mirror-image relationship with each other. Therefore, the following describes details of the structure of the first rotary portion 41A, and description of details of the structure of the second rotary portion 41B is omitted by denoting corresponding portions of these rotary portions with the same reference numerals.

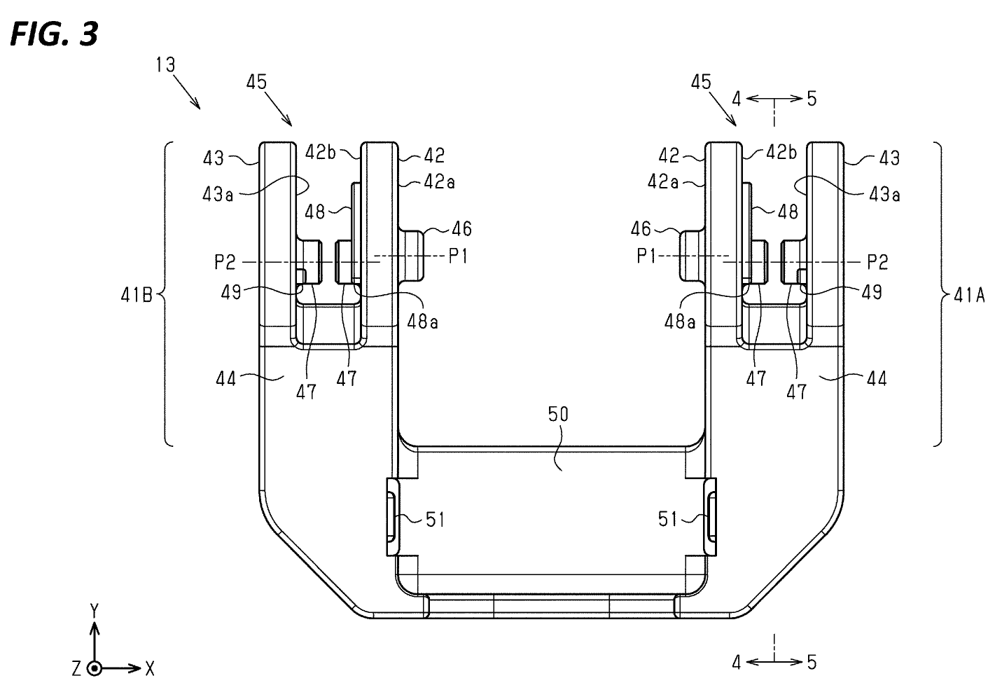

As shown in FIG. 3, the first rotary portion 41A includes a first rotary side wall 42 and a second rotary side wall 43 that are plate-shaped and spaced apart from each other in the X-axis direction, and a peripheral wall 44 connecting a part of a peripheral edge portion of the first rotary side wall 42 and a part of a peripheral edge portion of the second rotary side wall 43 to each other. The first rotary portion 41A also has an opening 45 through which the first fixing shaft 12A is inserted to be disposed between the first rotary side wall 42 and the second rotary side wall 43. The opening 45 is formed by regions of the peripheral edge portions of the first rotary side wall 42 and the second rotary side wall 43 in which the peripheral wall 44 is not formed.

The first rotary side wall 42 has a first surface 42a facing the main body 21 of the housing 11 and a second surface 42b opposite to the first surface 42a. A central portion of the first surface 42a of the first rotary side wall 42 is provided with a rotation shaft 46 that is inserted into the bearing portion 24 provided in the first side wall 21c of the main body 21 of the housing 11. The rotation shaft 46 has a circular column shape having a central axis at a first center P1. It should be noted that the bearing portion 24 into which the rotation shaft 46 is inserted has an oval shape extending in the Y-axis direction, whereas the rotation shaft 46 has a circular column shape. Therefore, the rotation shaft 46 is slidable in the bearing portion 24 in the direction in which the bearing portion 24 extends. Accordingly, the main body 21 of the housing 11 and the first rotary portion 41A are slidable relative to each other in the direction in which the bearing portion 24 extends, and are rotatable relative to each other about the first center P1 that is the center of the rotation shaft 46.

The second rotary side wall 43 has a third surface 43a facing the first rotary side wall 42. A central portion of the second surface 42b of the first rotary side wall 42 and a central portion of the third surface 43a of the second rotary side wall 43 are respectively provided with support shafts 47 for supporting the first fixing shaft 12A. The support shafts 47 have a circular column shape having a central axis at a second center P2. The second center P2 is set at a position eccentric to the first center P1.

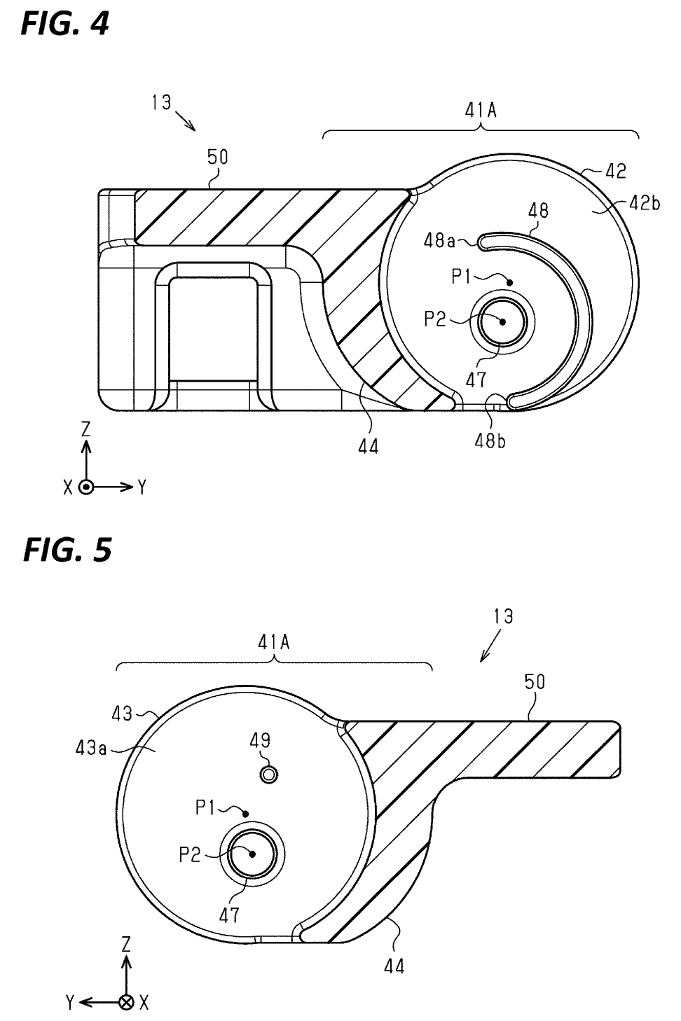

As shown in FIGS. 3 and 4, the second surface 42b of the first rotary side wall 42 is provided with a cam ridge 48. The cam ridge 48 is a ridge extending in an arc shape whose center is the second center P2. The cam ridge 48 is provided in a range of about 180 degrees around the second center P2 between the support shaft 47 and the opening 45. The cam ridge 48 has a first end portion 48a that is an end portion on one side in the direction in which the cam ridge 48 extends, and a second end portion 48b on the side opposite to the first end portion 48a.

As shown in FIGS. 3 and 5, the third surface 43a of the second rotary side wall 43 is provided with a cam protrusion 49 having a circular column shape. The cam protrusion 49 is smaller than the support shafts 47. The cam protrusion 49 is provided at a position facing the first end portion 48a of the cam ridge 48 on the second rotary side wall 43.

As shown in FIG. 3, the operation lever 13 includes a coupling portion 50 that couples the first rotary portion 41A and the second rotary portion 41B. The coupling portion 50 couples the peripheral wall 44 of the first rotary portion 41A and the peripheral wall 44 of the second rotary portion 41B. The coupling portion 50 is provided with lever lock portions 51. The lever lock portions 51 are locked to lock portions 52 (see FIG. 2) provided on the retainer 14 when the operation lever 13 is moved to a lever lock position, which is a second position described later. The operation lever 13 is retained at the lever lock position due to the lever lock portions 51 being locked to the lock portions 52. The lever lock portions 51 and the lock portions 52 are, for example, protrusions and recesses that are locked due to a complementary relationship.

### Configuration of First Fixing Shaft 12A and Second Fixing Shaft 12B

The first fixing shaft 12A and the second fixing shaft 12B have symmetrical structures that are in a mirror-image relationship with each other. Therefore, the following describes details of the structure of the first fixing shaft 12A, and description of details of the structure of the second fixing shaft 12B is omitted.

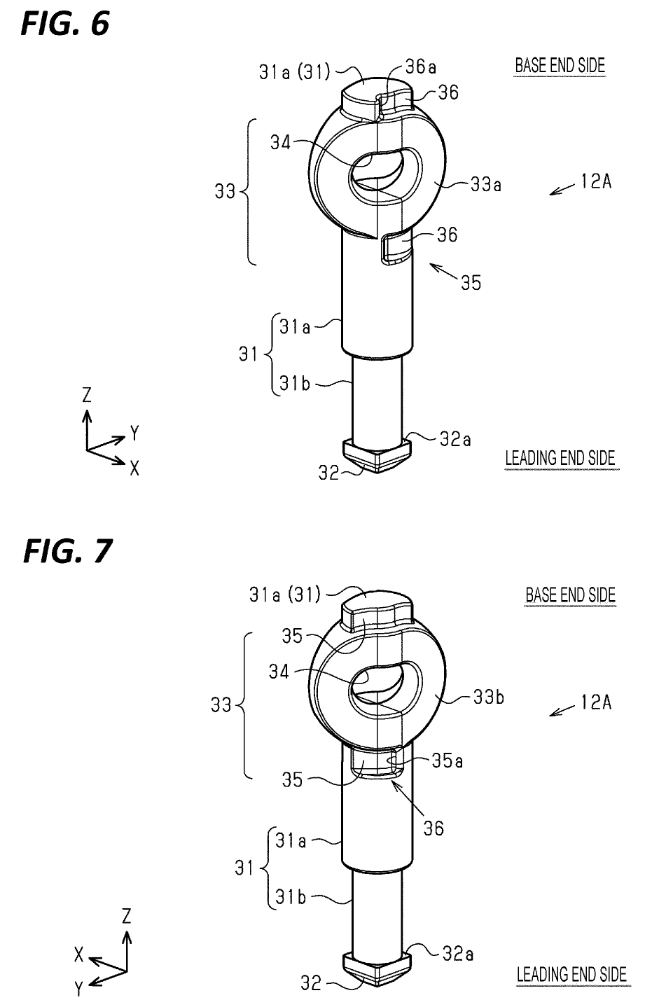

As shown in FIGS. 6 and 7, the first fixing shaft 12A includes a columnar shaft portion 31 extending in the Z-axis direction. FIGS. 6 and 7 are both perspective views of the first fixing shaft 12A as viewed from different directions.

The shaft portion 31 includes a large-diameter portion 31a on the Z-axis direction side and a small-diameter portion 31b on the side opposite to the Z-axis direction, which is thinner than the large-diameter portion 31a. The cross-sectional shape of the large-diameter portion 31a allows the large-diameter portion to be inserted into the through hole 26 of the first flange 25A and to rotate about an axis extending in the Z-axis direction in the through hole 26. The cross-sectional shape of the large-diameter portion 31a is, for example, a circular shape that is slightly smaller than the through hole 26. The cross-sectional shape of the small-diameter portion 31b is, for example, a circular shape that is smaller than the cross-sectional shape of the large-diameter portion 31a. Hereinafter, an end portion of the shaft portion 31 on the large-diameter portion 31a side will be referred to as a "base end", and an end portion of the shaft portion 31 on the small-diameter portion 31b side will be referred to as a "leading end".

The first fixing shaft 12A includes a lock protrusion 32 that is integrally formed with the leading end of the shaft portion 31, i.e., the leading end of the small-diameter portion 31b. The lock protrusion 32 protrudes radially outward from an outer circumferential surface of the shaft portion 31. The lock protrusion 32 has a lock surface 32a facing upward. The lock surface 32a has a non-circular peripheral shape. The lock protrusion 32 has, for example, a truncated pyramid shape that becomes gradually thinner in the direction from the base end to the leading end of the shaft portion 31. The peripheral shape of the lock surface 32a is not particularly limited as long as it is not a circular shape, and may be, for example, a polygonal shape such as a quadrilateral shape, or an elliptical shape.

As shown in FIG. 2, the shaft portion 31 of the first fixing shaft 12A is inserted through the through hole 26 of the first flange 25A. The shaft portion 31 is movable in the axial direction of the shaft portion 31 and rotatable about the axis of the shaft portion 31 in the through hole 26 of the first flange 25A.

As shown in FIGS. 6 and 7, the first fixing shaft 12A includes a fixing-side cam portion 33. The fixing-side cam portion 33 is formed integrally with an intermediate portion in the Z-axis direction of the large-diameter portion 31a of the shaft portion 31. The fixing-side cam portion 33 has a first surface 33a (see FIG. 6) on the X-axis direction side and a second surface 33b (see FIG. 7) opposite to the first surface 33a. The first surface 33a and the second surface 33b are bent into an L-shape as viewed from above so as to be closer to each other as they extend away from the shaft portion 31. In other words, the fixing-side cam portion 33 gradually becomes thinner as it extends away from the shaft portion 31. With this configuration, it is possible to secure a space for the fixing-side cam portion 33 to rotate about the axis of the shaft portion 31 in the first rotary portion 41A.

The fixing-side cam portion 33 includes a bearing hole 34 into which the support shafts 47 of the operation lever 13 are inserted. The bearing hole 34 is a through hole extending through the fixing-side cam portion from the first surface 33a to the second surface 33b. The inner circumferential shape of the bearing hole 34 is an oval shape extending orthogonally to the axis of the shaft portion 31. The bearing hole 34 is larger than the support shafts 47 of the operation lever 13, and accordingly, there is a gap between the bearing hole 34 and the support shafts 47. This gap allows the first fixing shaft 12A to rotate about the axis of the shaft portion 31 relative to the operation lever 13 in the state where the support shafts 47 are inserted into the bearing hole 34. It should be noted that a space that allows the fixing-side cam portion 33 to relatively rotate about the axis of the shaft portion 31 is secured in the first rotary portion 41A due to the above-described shapes of the first surface 33a and the second surface 33b of the fixing-side cam portion 33.

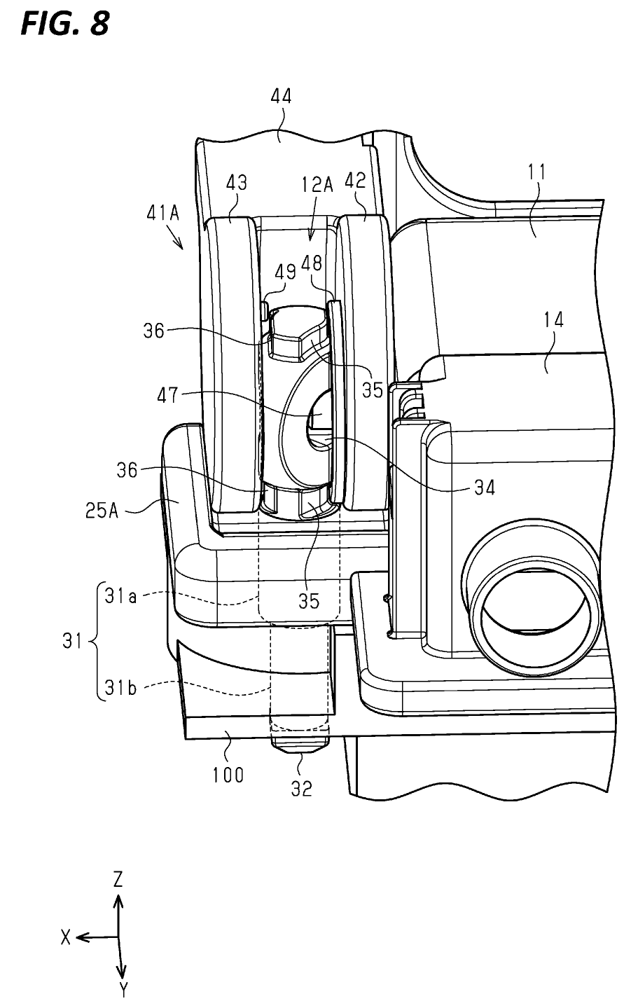

As shown in FIG. 7, first cam grooves 35 are provided along the circumferential direction of the shaft portion 31 in the outer circumferential surface of the large-diameter portion 31a of the shaft portion 31. The first cam grooves 35 are formed on both the base end side and the leading end side with respect to the fixing-side cam portion 33 in the large-diameter portion 31a of the shaft portion 31. As shown in FIG. 8, the cam ridge 48 of the operation lever 13 is accommodated in the first cam grooves 35. The cam ridge 48 moves in the first cam grooves 35 along with the rotation of the operation lever 13. As shown in FIG. 7, the first cam groove 35 on the leading end side with respect to the fixing-side cam portion 33 has, in an end portion on one side in the circumferential direction, a first cam end surface 35a with which the second end portion 48b of the cam ridge 48 comes into contact along with the rotation of the operation lever 13.

As shown in FIG. 6, second cam grooves 36 are provided along the circumferential direction of the shaft portion 31 in the outer circumferential surface of the large-diameter portion 31a of the shaft portion 31. The second cam grooves 36 are formed on both the base end side and the leading end side with respect to the fixing-side cam portion 33 in the large-diameter portion 31a of the shaft portion 31. As shown in FIG. 8, the cam protrusion 49 of the operation lever 13 is accommodated in the second cam grooves 36. The cam protrusion 49 moves in the second cam grooves 36 along with the rotation of the operation lever 13. As shown in FIG. 6, the second cam groove 36 on the base end side with respect to the fixing-side cam portion 33 has, in an end portion on one side in the circumferential direction, a second cam end surface 36a with which the cam protrusion 49 comes into contact along with the rotation of the operation lever 13.

The first fixing shaft 12A is made of resin. Examples of the resin forming the first fixing shaft 12A include at least one of polyacetal resin, polybutylene terephthalate, and polyamide resin.

### Cam Mechanism

The connector 10 includes a first cam mechanism configured to convert movement of the operation lever 13 in an operating direction into movement of the first fixing shaft 12A. The connector 10 also includes a second cam mechanism configured to convert the movement of the operation lever 13 in the operating direction into movement of the second fixing shaft 12B. The first cam mechanism and the second cam mechanism have symmetrical structures that are in a mirror-image relationship with each other. Therefore, the following describes details of the structure of the first cam mechanism, and description of details of the structure of the second cam mechanism is omitted.

The first cam mechanism includes an axial direction cam that converts movement of the operation lever 13 in the operating direction into movement of the first fixing shaft 12A in an axial direction. The axial direction cam is an eccentric cam that is constituted by the fixing-side cam portion 33 of the first fixing shaft 12A and the first rotary portion 41A of the operation lever 13.

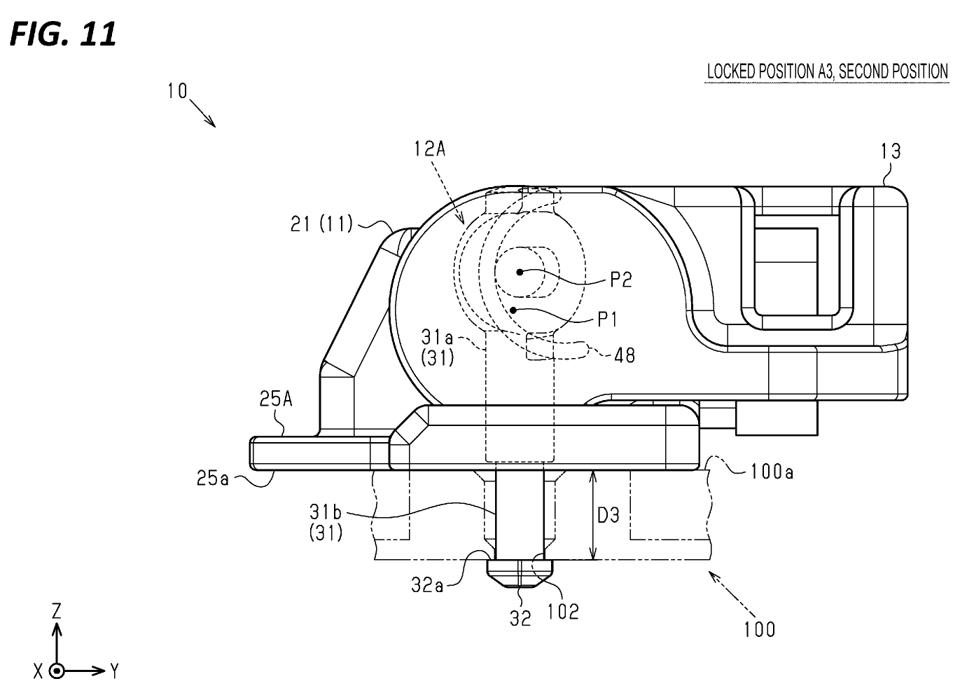

The axial direction cam converts movement of the operation lever 13 in a rotational direction about the first center P1 into movement of the first fixing shaft 12A in the axial direction. For example, the operation lever 13 is moved from a first position shown in FIG. 9 to a second position shown in FIG. 11 by being rotated about the first center P1 in a direction R1. The second position is the lever lock position. At this time, the first fixing shaft 12A moves upward, i.e., in the axial direction of the shaft portion 31 of the first fixing shaft 12A by being raised by the support shafts 47 relatively moving around the first center P1.

As described above, the bearing portion 24 has an oval shape, and therefore, the first rotary portion 41A of the operation lever 13 is slidable in the Y-axis direction relative to the main body 21 of the housing 11. Also, the bearing hole 34 has an oval shape, and therefore, the first rotary portion 41A of the operation lever 13 is slidable in the Y-axis direction relative to the first fixing shaft 12A as well. When the first fixing shaft 12A moves in the axial direction in conjunction with the rotation of the operation lever 13, the operation lever 13 slides relative to the main body 21 of the housing 11 and the first fixing shaft 12A. Accordingly, the first fixing shaft 12A can be moved in the axial direction without being caught by the through hole 26 of the first flange 25A.

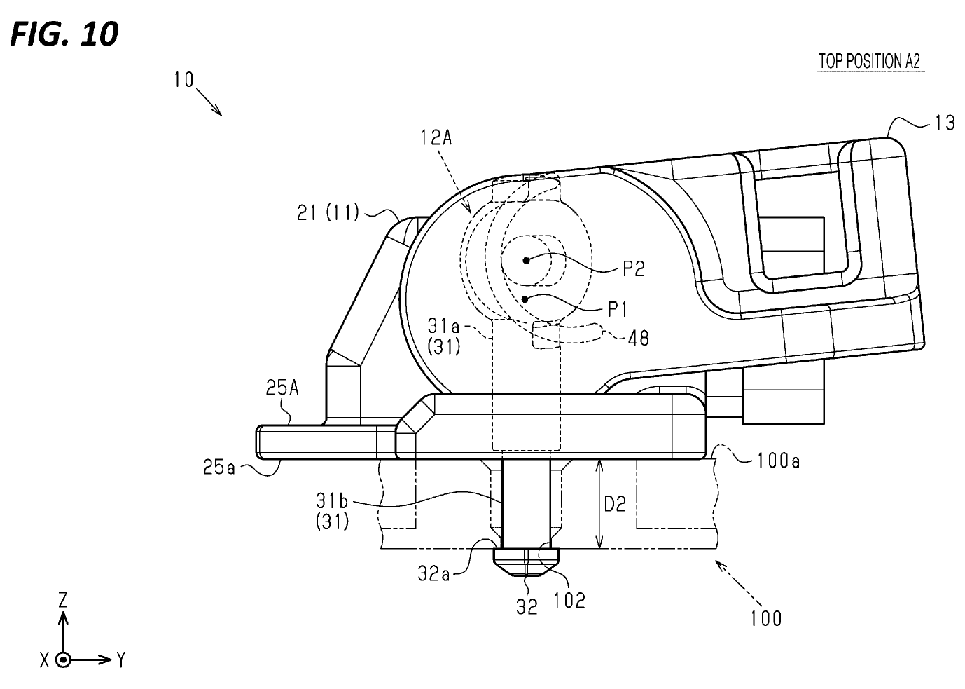

The axial direction cam is formed such that the first fixing shaft 12A moves between a locked position A3 shown in FIG. 11 and an initial position A1 shown in FIG. 9 in conjunction with the movement of the operation lever 13 in the operating direction. Also, the axial direction cam is formed such that the first fixing shaft 12A moves from the locked position A3 to the initial position A1 via a top position A2 shown in FIG. 10.

As shown in FIG. 9, the initial position A1 is set such that the distance in the Z-axis direction from the lower surface 25a of the first flange 25A to the lock surface 32a of the lock protrusion 32 of the first fixing shaft 12A is larger than the thickness of the casing 100. Hereinafter, this distance when the first fixing shaft 12A is located at the initial position A1 will be referred to as a "distance D1". An example of the initial position A1 is the position at which the distance to the lock surface 32a of the lock protrusion 32 of the first fixing shaft 12A becomes the maximum. When the first fixing shaft 12A is at the initial position A1, the second center P2 of the support shafts 47 is between the first center P1 and the first flange 25A. In other words, the second center P2 of the support shafts 47 is closer to the first flange 25A than the first center P1 is.

As shown in FIG. 10, the top position A2 is set as a position at which the second center P2 is farthest from the first flange 25A in the Z-axis direction. The top position A2 can also be said to be a position at which the distance to the lock surface 32a of the lock protrusion 32 of the first fixing shaft 12A is shortest. Hereinafter, this distance when the first fixing shaft 12A is located at the top position A2 will be referred to as a "distance D2". When the first fixing shaft 12A is located at the top position A2, the distance D2 is equal to the thickness of the casing 100 or slightly smaller than the thickness of the casing 100.

As shown in FIG. 11, the locked position A3 is set such that the distance in the Z-axis direction to the lock surface 32a of the lock protrusion 32 of the first fixing shaft 12A is shorter than that when the first fixing shaft is located at the initial position A1. Hereinafter, this distance when the first fixing shaft 12A is located at the locked position A3 will be referred to as a "distance D3". The initial position A1 is set as a position at which the above-described distance is longer than that when the first fixing shaft is located at the locked position A3. Accordingly, the distance D3 when the first fixing shaft 12A is located at the locked position A3 is shorter than the distance D1 when the first fixing shaft 12A is located at the initial position A1.

Also, the distance D3 when the first fixing shaft 12A is located at the locked position A3 is slightly longer than the distance D2 when the first fixing shaft 12A is located at the top position A2. The distance D3 when the first fixing shaft 12A is located at the locked position A3 is equal to the thickness of the casing 100, or slightly smaller or slightly larger than the thickness of the casing 100.

An example of the locked position A3 is the position of the first fixing shaft when the operation lever 13 is rotated 180 degrees from the initial position A1 in the direction R1 about the first center P1. An example of the locked position A3 is the position of the first fixing shaft when the operation lever 13 is rotated 15 degrees from the top position A2 in the direction R1 about the first center P1.

The first cam mechanism includes a rotational direction cam that converts the movement of the operation lever 13 in the operating direction into movement of the first fixing shaft 12A in a rotational direction. The rotational direction cam is a groove cam that is constituted by the fixing-side cam portion 33 of the first fixing shaft 12A and the first cam grooves 35 and the second cam grooves 36 of the operation lever 13.

The groove cam converts the movement of the operation lever 13 in the rotational direction about the first center P1 into movement of the first fixing shaft 12A about its axis. For example, the operation lever 13 is moved from the first position shown in FIG. 9 to the second position shown in FIG. 11. At this time, the cam ridge 48 of the first rotary portion 41A moves in the first cam grooves 35 around the first center P1, and the second end portion 48b of the cam ridge 48 comes into contact with the first cam end surface 35a of the first cam groove 35 at a specific first timing. Thereafter, the cam ridge 48 further moves and pushes the first cam end surface 35a of the first cam groove 35, rotating the first fixing shaft 12A about the axis of the shaft portion 31 in a first direction (e.g., counterclockwise direction). Therefore, the cam ridge 48 is a pushing portion that moves around the first center P1 when the operation lever 13 is moved in the rotational direction, and comes into contact with the first fixing shaft 12A and rotates the first fixing shaft 12A about the axis.

Also, the operation lever 13 is moved from the second position shown in FIG. 11 to the first position shown in FIG. 9. At this time, the cam protrusion 49 of the first rotary portion 41A moves in the second cam grooves 36 around the first center P1, and comes into contact with the second cam end surface 36a of the second cam groove 36 at a specific second timing. Thereafter, the cam protrusion 49 further moves and pushes the second cam end surface 36a of the second cam groove 36, rotating the first fixing shaft 12A about the axis of the shaft portion 31 in a second direction (e.g., clockwise direction). Therefore, the cam protrusion 49 is a pushing portion that moves around the first center P1 when the operation lever 13 is moved in the rotational direction, and comes into contact with the first fixing shaft 12A and rotates the first fixing shaft 12A about the axis.

The rotational direction cam is formed such that the lock protrusion 32 of the first fixing shaft 12A and a fixing through hole 102 provided in the casing 100 have a specific relationship with each other in conjunction with the movement of the operation lever 13 in the operating direction. More specifically, the rotational direction cam is formed to change the position of the first fixing shaft 12A between a rotational position about the axis at which the lock protrusion 32 can pass through the fixing through hole 102 and a rotational position about the axis at which the lock protrusion 32 cannot pass through the fixing through hole 102.

As shown in FIG. 2, the casing 100 to which the connector 10 is to be attached includes one connector hole 101 and two fixing through holes 102. The connector hole 101 is a through hole into which a part of the connector 10, e.g., the fitting portion accommodating the terminals is inserted. The fixing through holes 102 are through holes through which the first fixing shaft 12A and the second fixing shaft 12B are inserted. The fixing through holes 102 each include a lock portion whose cross section orthogonal to the Z-axis direction has a specific inner circumferential shape. In the lock portion, the inner circumferential shape of the fixing through hole 102 is the same as the peripheral shape of the lock protrusion 32, i.e., the peripheral shape of the lock surface 32a provided at the leading end of each of the shaft portions 31 of the first fixing shaft 12A and the second fixing shaft 12B, and is slightly larger than the peripheral shape.

Accordingly, when the inner circumferential shape of the lock portion of the fixing through hole 102 matches with the peripheral shape of the lock protrusion 32 as viewed in the axial direction of the shaft portion 31, the lock protrusion 32 can pass through the fixing through hole 102. Also, when the inner circumferential shape of the lock portion of the fixing through hole 102 does not match with the peripheral shape of the lock protrusion 32, the lock protrusion 32 abuts against the casing 100 and cannot pass through the fixing through hole 102.

It should be noted that the inner circumferential shape of the above-described cross section of the fixing through hole 102 may be constant or may vary. For example, in the case of the fixing through hole 102 of the casing 100 shown with an imaginary line in FIG. 9, the inner circumferential shape of the above-described cross section becomes smaller in the direction from a mounting surface 100a side to the opposite surface side. At the surface opposite to the mounting surface 100a, the inner circumferential shape of the above-described cross section is the same as the peripheral shape of the lock surface 32a and is slightly larger than the peripheral shape. Accordingly, the lock portion is an end portion of the fixing through hole 102 on the side opposite to the mounting surface 100a.

Hereinafter, the case where the inner circumferential shape of the fixing through hole 102 matches with the peripheral shape of the lock protrusion 32 when viewed in the axial direction of the shaft portion 31 will be referred to as a case where the rotational position of the first fixing shaft 12A about its axis is a matched position. Also, the case where the inner circumferential shape of the fixing through hole 102 does not match with the peripheral shape of the lock protrusion 32 when viewed in the axial direction of the shaft portion 31 will be referred to as a case where the rotational position of the first fixing shaft 12A about its axis is an unmatched position.

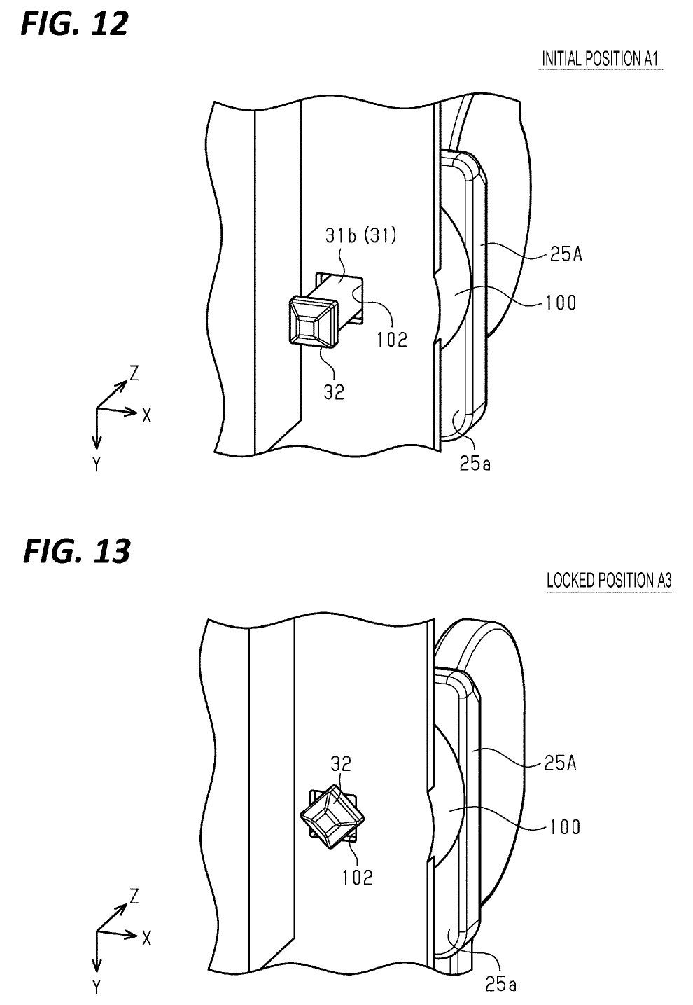

As shown in FIG. 12, the rotational direction cam rotates the first fixing shaft 12A such that the rotational position of the first fixing shaft 12A about the axis is the matched position when the first fixing shaft 12A is located at the initial position A1. As shown in FIG. 13, the rotational direction cam rotates the first fixing shaft 12A such that the rotational position of the first fixing shaft 12A about the axis is the unmatched position when the first fixing shaft 12A is located at the locked position A3. Therefore, the rotational position of the first fixing shaft 12A about the axis when the first fixing shaft 12A is located at the locked position A3 is different from the rotational position of the first fixing shaft 12A about the axis when the first fixing shaft 12A is located at the initial position A1. Also, the rotational direction cam rotates the first fixing shaft 12A such that the rotational position of the first fixing shaft 12A about the axis is the unmatched position when the first fixing shaft 12A is located at a position other than the initial position A1 between the locked position A3 and the initial position A1.

### Functions of Present Embodiment

The following describes functions of the present embodiment.

The following describes functions of the present embodiment referring to the operation of the first fixing shaft 12A as an example, but the second fixing shaft 12B operates similarly to the first fixing shaft 12A.

When the connector 10 is to be attached to the casing 100, first, the operation lever 13 is placed at the first position shown in FIG. 9 to place the first fixing shaft 12A at the initial position A1.

Next, a part of the connector 10 is inserted into the connector hole 101 of the casing 100 from the mounting surface 100a side of the casing 100, and the first fixing shaft 12A and the second fixing shaft 12B are inserted into the fixing through holes 102 of the casing 100. Then, the connector 10 is placed on the mounting surface 100a such that the lower surface 25a of the first flange 25A comes into contact with the mounting surface 100a of the casing 100.

Next, the operation lever 13 is moved from the first position shown in FIG. 9 to the second position shown in FIG. 11 by being rotated a predetermined angle (for example, 180 degrees) about the first center P1.

In conjunction with the rotation of the operation lever 13 operated as described above, the first fixing shaft 12A moves in the axial direction and rotates about the axis. More specifically, in conjunction with the rotation of the operation lever 13, the first fixing shaft 12A is moved by the axial direction cam upward from the initial position A1 to the top position A2 shown in FIG. 10 and then downward from the top position A2 to the locked position A3 shown in FIG. 11. Also, in conjunction with the rotation of the operation lever 13, the rotational position of the first fixing shaft 12A about the axis is changed by the rotational direction cam from the matched position at which the lock protrusion 32 can pass through the fixing through hole 102 to the unmatched position at which the lock protrusion 32 cannot pass through the fixing through hole 102.

As the first fixing shaft 12A moves from the initial position A1 to the locked position A3, the lock protrusion 32 approaches the first flange 25A as shown in FIG. 11. When the first fixing shaft 12A is located at the locked position A3, the casing 100 is sandwiched between the lock protrusion 32 and the first flange 25A, and thus the connector 10 is fixed to the casing 100.

Here, holding pressure applied from the lock protrusion 32 and the first flange 25A to the casing 100 becomes the maximum when the first fixing shaft 12A is located at the top position A2 shown in FIG. 10. Although the holding pressure becomes slightly weak when the first fixing shaft 12A reaches the locked position A3 past the top position A2, sufficient holding pressure is obtained even when the first fixing shaft 12A is located at the locked position A3.

When the connector 10 is to be removed from the casing 100, a procedure reverse to the above operation is carried out. That is to say, the operation lever 13 is moved from the second position to the first position by being rotated about the first center P1 in the direction opposite to the direction in which the operation lever 13 is rotated about the first center P1 during the attachment of the connector 10. This allows the connector 10 to be removed from the casing 100.

### Effects of Present Embodiment

The following describes effects of the present embodiment.

(1) The connector 10 includes the housing 11, the first fixing shaft 12A made of resin and configured to fix the housing 11 to the casing 100, and the operation lever 13 for operating the first fixing shaft 12A. The housing 11 includes the main body 21 and the first flange 25A protruding outward from the main body 21. The first fixing shaft 12A includes the shaft portion 31 that is inserted through the through hole 26 provided in the first flange 25A, and the lock protrusion 32 protruding from the outer circumferential surface of the shaft portion 31 and configured to sandwich the casing 100 between the lock protrusion 32 and the first flange 25A. The first fixing shaft 12A and the operation lever 13 include the cam mechanism configured to convert movement of the operation lever 13 in the operating direction into movement of the first fixing shaft 12A in the axial direction and convert the movement of the operation lever 13 in the operating direction into movement of the first fixing shaft 12A in the rotational direction about the axis. In conjunction with the movement of the operation lever 13 in the operating direction, the first fixing shaft 12A moves between the locked position A3 at which the casing 100 is sandwiched between the first flange 25A and the lock protrusion 32 and the initial position A1 at which the distance between the lock protrusion 32 and the first flange 25A is longer than that at the locked position A3. The rotational position of the first fixing shaft 12A about the axis when the first fixing shaft is located at the locked position A3 is different from the rotational position of the first fixing shaft 12A about the axis when the first fixing shaft is located at the initial position A1.

According to this configuration, the first fixing shaft 12A used to fix the housing 11 to the casing 100 is made of resin. This prevents the occurrence of metal corrosion in the first fixing shaft 12A in the state where the connector 10 is fixed to the casing 100, and prevents the first fixing shaft 12A from getting stuck due to the metal corrosion. Therefore, deterioration of handleability due to the metal corrosion can be suppressed. In addition, the connector 10 can be fixed to the casing 100 by moving the operation lever 13 in the predetermined operating direction, which is a simple operation that an attachment operator can perform with his own hands. This eliminates the need for a special tool for fixing, such as an impact driver used to fasten bolts.

(2) The cam mechanism includes the axial direction cam that converts movement of the operation lever 13 in the rotational direction into movement of the first fixing shaft 12A in the axial direction. The first fixing shaft 12A is coupled to the operation lever 13 in such a manner as to be rotatable relative to the operation lever 13 about the second center P2 that is eccentric to the first center P1, which is the rotation center of the operation lever 13. With this configuration, by employing an eccentric cam having a simple structure, it is possible to suppress an increase in the number of components of members constituting the cam mechanism and complication of the shapes of the members constituting the cam mechanism.

(3) The position of the first fixing shaft 12A when the second center P2 is farthest from the first flange 25A is defined as the top position A2. The axial direction cam is configured such that the first fixing shaft 12A moves from the locked position A3 to the initial position A1 via the top position A2 in conjunction with the movement of the operation lever 13 in the operating direction.

According to this configuration, when the first fixing shaft 12A is located at the top position A2, the holding pressure applied by the lock protrusion 32 of the first fixing shaft 12A to press the casing 100 becomes the maximum, and a strong resisting force that pushes back the lock protrusion 32 is generated as a reaction. Therefore, a force exceeding this resisting force is necessary to pass through the top position A2 when the operation lever 13 is moved from the position at which the first fixing shaft 12A is located at the locked position A3 to the position at which the first fixing shaft 12A is located at the initial position A1. Accordingly, when the first fixing shaft 12A is located at the locked position A3, even if a force is applied by unintentional contact or the like to the operation lever 13 in a direction to rotate the operation lever 13, it is possible to suppress rotation of the operation lever 13 in such a direction that the fixing of the connector is canceled. As a result, the connector 10 can be stably fixed to the casing 100.

(4) The cam mechanism includes the rotational direction cam that converts the movement of the operation lever 13 in the rotational direction into movement of the first fixing shaft 12A in the rotational direction about the axis. The rotational direction cam includes the cam ridge 48 and the cam protrusion 49 as pushing portions provided on the operation lever 13. When the operation lever 13 is moved in the rotational direction, the cam ridge 48 and the cam protrusion 49 move around the first center P1, which is the rotation center of the operation lever 13, and come into contact with the first fixing shaft 12A and rotate the first fixing shaft 12A about the axis.

With this configuration, the structure of the rotational direction cam can be simplified. Therefore, it is possible to suppress an increase in the number of components of members constituting the cam mechanism and complication of the shapes of the members constituting the cam mechanism.

(5) The connector includes the first flange 25A and the second flange 25B located on opposite sides with the main body 21 therebetween. The connector includes the first fixing shaft 12A inserted through the through hole provided in the first flange 25A and the second fixing shaft 12B inserted through the through hole provided in the second flange 25B, and the first fixing shaft 12A and the second fixing shaft 12B operate in conjunction with operation of the single operation lever 13.

With this configuration, the connector 10 can be fixed to the casing 100 more stably with the two fixing shafts, i.e., the first fixing shaft 12A and the second fixing shaft 12B. Also, the two fixing shafts can be easily operated by one operation.

(6) The position of the operation lever 13 when the first fixing shaft 12A is located at the locked position A3 is defined as the lever lock position. The lever lock position is the second position. The operation lever 13 includes the lever lock portions 51 that retain the operation lever 13 at the second position by being locked to the retainer 14 attached to the housing 11 when the operation lever 13 comes to the lever lock position.

According to this configuration, when the operation lever 13 is located at the lever lock position, even if a force is applied to the operation lever 13 by unintentional contact or the like in a direction to rotate the operation lever 13, it is possible to suppress rotation of the operation lever 13 in the direction in which the fixing of the connector by the first fixing shaft 12A is canceled. As a result, the connector 10 can be stably fixed to the casing 100.

### Other Embodiments

The above embodiment can be implemented with the following modifications. The above embodiment and the following modification examples can be implemented in combination with each other as long as there is no technical contradiction.

The material of the housing 11 is not particularly limited. The housing 11 is made of resin, for example. In this case, for example, the resins exemplified for the first fixing shaft 12A can be used to form the housing 11. The material of the operation lever 13 is not particularly limited. The operation lever 13 is made of resin, for example. In this case, for example, the resins exemplified for the first fixing shaft 12A can be used to form the operation lever 13.

The axial direction cam may be configured such that the first fixing shaft 12A does not pass through the top position A2 while moving from the locked position A3 to the initial position A1 in conjunction with the movement of the operation lever 13 in the operating direction. For example, the axial direction cam may be configured such that the top position A2 is the locked position A3, or a position closer to the initial position A1 than the top position A2 is the locked position A3.

The axial direction cam is not limited to the eccentric cam, and may be any mechanism that converts the movement of the operation lever 13 in the operating direction into the movement of the first fixing shaft 12A in the axial direction. For example, it is also possible to adopt an operation lever 13 whose operating direction is a first direction other than the axial direction of the first fixing shaft 12A, and the axial direction cam may convert linear movement of the operation lever 13 in the first direction into the movement of the first fixing shaft 12A in the axial direction.

The rotational direction cam is not limited to the configuration in the above embodiment. For example, the operation lever 13 may include recessed portions corresponding to the first cam grooves 35 and the second cam grooves 36, and the first fixing shaft 12A may include protrusions corresponding to the cam ridge 48 and the cam protrusion 49. Also, the rotational direction cam may be configured such that the first fixing shaft 12A rotates by coming into contact with a part of the operation lever 13 while being moved in the axial direction by the axial direction cam.

A configuration is also possible in which an operation lever 13 for operating the first fixing shaft 12A and an operation lever 13 for operating the second fixing shaft 12B are provided independently of each other.

The first fixing shaft 12A and the second fixing shaft 12B may be identical components, rather than having symmetrical structures. In this case, for example, the cam protrusion 49 may be provided on the second surface 42b of the second rotary portion 41B, and the cam ridge 48 may be provided on the third surface 43a facing the second surface 42b. By using the identical components as the first fixing shaft 12A and the second fixing shaft 12B, it is possible to reduce the number of components of the connector 10.

The lock portions 52 to which the lever lock portions 51 are locked may be provided on the housing 11 or a member attached to the housing 11 other than the retainer 14.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing;
a fixing shaft made of resin and configured to fix the housing to a plate-shaped casing; and
an operation lever for operating the fixing shaft,
wherein the housing includes a main body and a flange protruding outward from the main body,
the fixing shaft includes a shaft portion that is inserted through a through hole provided in the flange and a lock protrusion protruding from an outer circumferential surface of the shaft portion and configured to sandwich the casing between the lock protrusion and the flange,
the fixing shaft and the operation lever include a cam mechanism configured to convert movement of the operation lever in an operating direction into movement of the fixing shaft in an axial direction and convert the movement of the operation lever in the operating direction into movement of the fixing shaft in a rotational direction about an axis,
in conjunction with the movement of the operation lever in the operating direction, the fixing shaft moves between a locked position at which the casing is sandwiched between the flange and the lock protrusion and an initial position at which a distance between the lock protrusion and the flange is longer than that at the locked position, and
a rotational position of the fixing shaft about the axis when the fixing shaft is located at the locked position is different from a rotational position of the fixing shaft about the axis when the fixing shaft is located at the initial position.

2. The connector according to claim 1,
wherein the cam mechanism includes an axial direction cam that converts movement of the operation lever in a rotational direction into the movement of the fixing shaft in the axial direction, and
the fixing shaft is coupled to the operation lever in such a manner as to be rotatable relative to the operation lever about a second center that is eccentric to a first center that is a rotation center of the operation lever.

3. The connector according to claim 2,
wherein, when a position of the fixing shaft when the second center is farthest from the flange is defined as a top position,
the axial direction cam is configured such that the fixing shaft moves from the locked position to the initial position via the top position in conjunction with the movement of the operation lever in the operating direction.

4. The connector according to claim 1,
wherein the cam mechanism includes a rotational direction cam that converts movement of the operation lever in a rotational direction into the movement of the fixing shaft in the rotational direction about the axis,
the rotational direction cam includes a pushing portion provided on the operation lever, and
when the operation lever is moved in the rotational direction, the pushing portion moves around a first center that is a rotation center of the operation lever, comes into contact with the fixing shaft, and rotates the fixing shaft about the axis.

5. The connector according to claim 1,
wherein the flange includes a first flange and a second flange located on opposite sides with the main body therebetween,
the fixing shaft includes a first fixing shaft inserted through the through hole provided in the first flange and a second fixing shaft inserted through the through hole provided in the second flange, and
the first fixing shaft and the second fixing shaft operate in conjunction with operation of the single operation lever.

6. The connector according to claim 1,
wherein, when a position of the operation lever when the fixing shaft is located at the locked position is defined as a lever lock position,
the operation lever includes a lever lock portion configured to retain the operation lever at the lever lock position by being locked to the housing or a member attached to the housing when the operation lever comes to the lever lock position.
